(19) United States
(12) Patent Application Publication
(10) Pub. No.: US 2026/0341967 A1
(43) Pub. Date: Oct. 29, 2026

(54) SYSTEM AND METHOD FOR HIGH PRECISION DYNAMIC WIRELESS NETWORK ACCESS MANAGEMENT WITH A METASURFACE INTEGRATED WIRELESS IDENTIFICATION TAG AT AN INFORMATION HANDLING SYSTEM

(71) Applicant: Dell Products LP, Round Rock, TX (US)

(72) Inventors: Harpreet S. Narula, Austin, TX (US); Tejinder Singh, Manotick (CA); Navjot Kaur Khaira, Manotick (CA)

(73) Assignee: Dell Products LP, Round Rock, TX (US)

(21) Appl. No.: 19/191,914

(22) Filed: Apr. 28, 2025

(51) Int. Cl. H01Q 15/00; H01Q 1/22

(52) U.S. Cl. CPC H01Q 15/0086; H01Q 1/2208

(57) ABSTRACT

A system and method of monitoring wireless network access includes a reconfigurable metasurface unit cell array, a metasurface hardware controller, and a metasurface power management unit to provide power to the metasurface hardware controller, wherein the reconfigurable unit cell array manipulates radiofrequency (RF) waves of incident RF signals transmitted or received within a RF environment. The metasurface unit cell array includes a unique identification (ID) circuit to receive, from a unique ID circuit writer at an administrator system, wireless network access permission data describing accessibility to partitioned wireless connections to a provisioned wireless network. The metasurface hardware controller to execute machine readable program code instructions of a network access ID management module to adjust the reconfigurable metasurface unit cells to adjust reflection of incident RF signals and prohibit access to restricted partitioned wireless connections in the provisioned wireless network based on the wireless network access permission data.

### FIELD OF THE DISCLOSURE

The present disclosure generally relates to an metasurface unit cell array used to enhance wireless transmissions and reception at an information handling system. More specifically, the present disclosure relates to a reconfigurable metasurface unit cell array integrated into an information handling system, such as a laptop, to enhance signal quality and directivity among a plurality of wireless antennas as well as to conduct dynamic wireless network access management.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system include one or more wireless interface adapters for operating wireless communications via one or more wireless protocols.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system including a metasurface unit cell array with a unique identification (ID) circuit and a metasurface hardware controller executing machine readable code instructions of a network access ID management module according to an embodiment of the present disclosure;

FIG. 2 is a block diagram illustrating an information handling system including a metasurface unit cell array with a unique identification (ID) circuit and a metasurface hardware controller executing machine readable code instructions of a network access ID management module according to another embodiment of the present disclosure;

FIG. 3A is an exploded graphic diagram illustrating a perspective view of a reconfigurable metasurface unit cell of a metasurface unit cell array according to an embodiment of the present disclosure;

FIG. 3B is a side, exploded graphic diagram illustrating a cross-section of a reconfigurable metasurface unit cell of a metasurface unit cell array according to another embodiment of the present disclosure;

FIG. 4 is a top view graphic diagram showing a metasurface unit cell array including a unique ID circuit and an exploded perspective view graphic diagram showing a reconfigurable metasurface unit cell according to an embodiment of the present disclosure;

FIG. 5 is a top view graphic diagram showing a reconfigurable metasurface unit cell array including a unique ID circuit and an ultra-wideband (UWB) circuit interfacing with an administrator information handling system according to an embodiment of the present disclosure;

FIG. 6 is a graphic diagram showing a plurality of reconfigurable metasurface unit cell arrays that each including a unique ID circuit interfacing with an administrator information handling system and assigned a plurality of tiers for wireless network access according to an embodiment of the present disclosure; and

FIG. 7 is a flow diagram of a method of monitoring wireless network access within a radiofrequency (RF) environment by information handling systems having metasurface unit cell arrays including a unique ID circuit and an ultra-wideband (UWB) circuit according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless networks may offer a variety of users' of information handling systems to access wireless connections in a radiofrequency (RF) environment in order to provide the users with access to the World Wide Web or the internet in general. Some of these wireless connections may include “guest” service set identifier (SSID) that provides controlled access to certain frequencies or bandwidths within the wireless network while other wireless connections may include greater authorization to access different or additional frequency and bandwidths for access to more secure wireless networks. Managing wireless network access in large buildings, for examples, or within a given radiofrequency (RF) environments may present complex challenges. These challenges may be exasperated especially when different users, such as employees, executives, and visitors, require varying levels of access to the wireless network. Traditional methods such as the use of static ID cards or manual network configuration fail to provide the dynamic adaptability and precision needed for modern RF environments within a wireless network. These methods lack real-time location tracking and the ability to reconfigure network access based on user movement within the RF environment, thereby resulting in potential security risks and inefficiencies in wireless network management.

Embodiments of the present specification describes a system and method of monitoring wireless network access using a reconfigurable metasurface unit cell array. In an embodiment, the information handling system includes a hardware processor, a memory device, a wireless interface adapter, and a power management unit (PMU) to provide power to the hardware processor, the memory device, and the wireless interface adapter to transceive wireless network data within a RF environment. The information handling system may also include a reconfigurable metasurface unit cell array operatively coupled to a chassis surface of the information handling system to manipulate electromagnetic (EM) waves of incident radiofrequency signals transmitted or received by plural radiofrequency (RF) antennas on the information handling system, wherein the reconfigurable metasurface unit cell array includes a plurality of reconfigurable metasurface unit cells to adjust and control reflection of incident radiofrequency signals. In embodiments of the present disclosure, a unique identification (ID) circuit formed on the reconfigurable metasurface unit cell array may receive, from a unique ID circuit writer at an administrator information handling system, wireless network access permission data describing accessibility to wireless connections of various portions of a wireless network within the RF environment. A metasurface hardware controller of the reconfigurable metasurface unit cell array may execute machine readable program code instructions of a network access ID management module to receive the wireless network access permission data. The metasurface hardware controller then determines how to adjust the reconfigurable metasurface unit cells to adjust or control reflection of incident radiofrequency signals transmitted from the information handling system or received at the information handling system in particular bands or channels depending on wireless network access permissions received. This control may include activating metasurface unit cells or adjusting metasurface unit cells in the metasurface unit cell array to enable reflection of RF signals in permitted frequency channels or bands included in the wireless network access permissions in an embodiment. This control may also include deactivating metasurface unit cells or adjusting metasurface unit cells in the metasurface unit cell array to create null zones to disable reflection of RF signals in unpermitted frequency channels or bands excluded from the wireless network access permissions in other embodiments. In an embodiment, the network access permission data may describe accessibility to wireless connections to portions of a wireless network or different wireless networks from data defining access levels depending on various reported physical locations within a physical building having an RF environment.

In an embodiment, the reconfigurable metasurface unit cell array may include an ultra-wideband (UWB) circuit to track a location of the information handling system and restrict the access to specific service set identifiers (SSIDs), frequency channels, and frequency bandwidths within the RF environment based on location via control of the metasurface unit cell array. This may allow for precision location tracking (e.g., within centimeters of location) of the information handling system within the RF environment and various portions of the wireless network or among plural wireless networks.

In an embodiment, the reconfigurable metasurface unit cells of the reconfigurable metasurface unit cell array each include a set of resonant structures formed on a dielectric substrate to receive the incident RF signals. The reconfigurable metasurface unit cell array may include a metasurface hardware controller to implement phase-shift or phase adjustment in reflecting or resonating those RF signals from those resonant structures. In one embodiment, the reconfigurable metasurface unit cells may include a set of concentric resonant structures and a metal fixed tab formed within the concentric resonant structures. In these embodiments, a plurality of reconfigurable metasurface unit cells formed with a set of concentric resonant structures that have one or more phase change material resonant structures of the concentric resonant structures made of a phase change material that, when heated by a refractory heater, switches between a conductive material state to a dielectric material state to adjust phase change in reflection of the reflected radiofrequency signal across the plurality of reconfigurable metasurface unit cells. In an embodiment, the metasurface hardware controller may adjust each reconfigurable metasurface unit cell with power supplied to contact pads operatively coupled to one or more refractory heaters from a metasurface power source controlled by the metasurface hardware controller. For example, providing power to the first refractory heater is used to provide a heat pulse to at least one of the phase change material concentric resonant structures made of the phase change material to adjust a phase shift of the reflected radiofrequency signal at the surface of that reconfigurable metasurface unit cell.

In other embodiments, the resonant structures of the reconfigurable metasurface unit cells of the reconfigurable metasurface unit cell array may include passive resonant structures operatively coupled with a microwave circuit to a tunable phase-shifting circuit such as a tunable phase-delay circuit or tunable varactor. The reconfigurable metasurface unit cell array may include a metasurface hardware controller to implement phase-shift or phase adjustment in reflecting or resonating those RF signals from those resonant structures via voltage or current supplied to tunable phase-shifting circuit to apply phase adjustment via the microwave circuit to resonating or reflecting RF signals at the surface of the reconfigurable metasurface unit cell.

Thus, the presently-described reconfigurable metasurface unit cell array of embodiments herein allows system administrators to remotely configure and reconfigure wireless access permissions at the reconfigurable metasurface unit cell arrays thereby dynamically adjusting which SSIDs or channels are allowed or blocked at any specific information handling system within the RF environment. In addition, the physical information handling system device may also be tracked within the RF environment using an ultra-wideband (UWB) circuit allowing for precise location detection of the information handling system within the RF environment for improved wireless network access management.

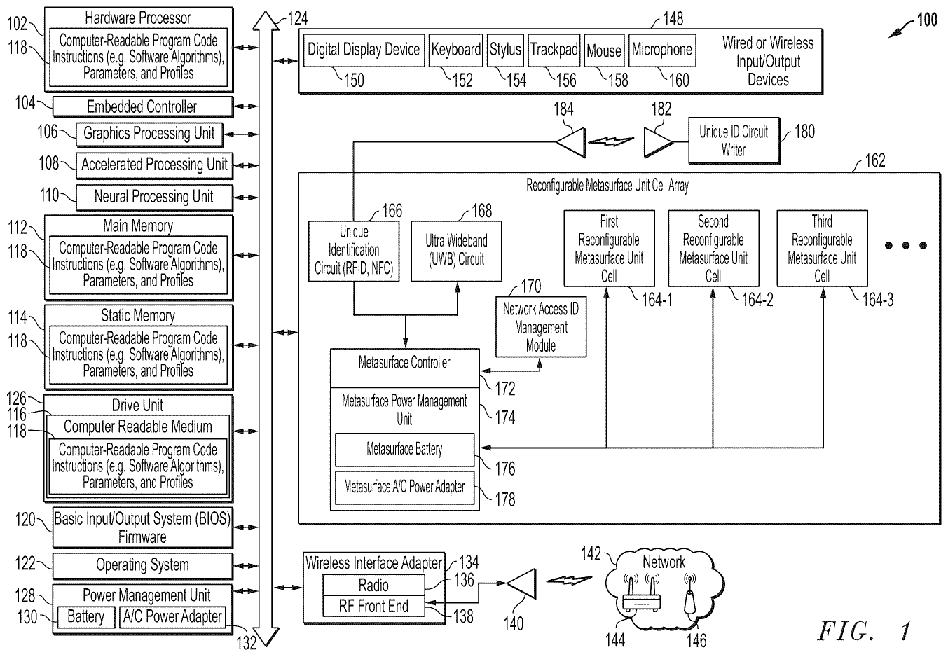

Turning now to the figures, FIG. 1 illustrates an information handling system 100 similar to the information handling systems according to several aspects of the present disclosure that may operate as a source or target radiofrequency device for use with the reconfigurable metasurfaces of the embodiments of the present disclosure. It is appreciated that terms such as “reconfigurable metasurface unit cell array” or “metasurface unit cell array” are meant to be understood as a metasurface that includes a plurality of reconfigurable unit cells that operate together to engage in, at least, reflecting, blocking, accepting, beamforming, and transmission of EM waves. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Machine readable program code instructions stored in static memory 114, main memory 112, or drive unit 126 may be involved in invoking such machine readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine readable program code instructions (e.g., software algorithms) parameters, and profiles 118 that may operate on servers or systems, remote data centers, or on-box in individual client information handling systems according to various embodiments herein. In some embodiments, it is understood that any or all portions of machine readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing machine readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device or wireless interface adapter 134 with its radio 136, RF front end 138 and one or more antennas 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems. In the context of the present disclosure the one or more antennas 140 may include one or more WiFi antennas operating at 2.4 GHz, 5 GHz, and/or 6 GHz frequencies, one or more Bluetooth antennas, and one or more 5G new radio (5G-NR) antennas that operate at Frequency Range 1 (FR1) (which includes sub-7 GHz frequency bands and those from 410 MHz to 7125 MHz 0 and Frequency Range 2 (FR2) (which includes frequency bands from 24.25 GHz to 71.0 GHz frequency bands). It is appreciated that the one or more antennas 140 may support any frequency or frequency range and the present specification appreciates the use of these other types of antennas 140. In some embodiments herein, plural wireless interface devices or wireless interface adapters 134 may utilize plural radios 136, RF front ends 138 for each type of radio protocol used with the one or more antennas 140. In other embodiments herein, a single wireless interface device or wireless interface adapter 134 may utilize a radio 136 and RF front end 138 for plural of the radio protocols used with the one or more antennas 140.

In other embodiments, the wireless interface device 134 with its radio 136, RF front end 138 and antennas 140 are used to communicate with a WWAN or WLAN wireless networks which may each include an AP 144 or base station 146 used to operatively couple the information handling system 100 to a network 142 via the wireless interface adapter 134 in the RF environment. In a specific embodiment, the wireless network 142 may include macro-cellular connections via one or more base stations 146 or a wireless AP 144 (e.g., Wi-Fi), or such as through licensed or unlicensed WWAN small cell base stations 146. In some embodiments, connectivity may be via wired or wireless connection. For example, wireless network wireless APs 144 or base stations 146 may be operatively connected to the information handling system 100. Wireless interface adapter 134 may include one or more RF subsystems (e.g., radio 136) with transmitter/receiver circuitry, modem circuitry, one or more antenna RF front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via the reconfigurable metasurface unit cell array 162. The receiver device 178 may be any other device and may include the AP 144, the base station 146, or any other computing device described herein. Additionally, the information handling system 100 and receiver device 178 may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of reflecting these types of mm waves to relay RF signals with directionality and enhanced gain or to generate null regions of low EMF blocking reflected RF signals in various embodiments herein.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes machine readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a machine readable medium that includes machine readable program code instructions, parameters, and profiles 118 or receives and executes machine readable program code instructions, parameters, and profiles 118 responsive to a propagated signal, so that a hardware device connected to a network 142 may communicate voice, video, or data over the network 142. Further, the machine readable program code instructions, parameters, and profiles 118 may be transmitted or received over the network 142 via the network interface device or wireless interface adapter 134.

The information handling system 100 may include a set of machine readable program code instructions, parameters, and profiles 118 that may be executed to cause the computer system to perform any one or more of the methods or computer-based functions disclosed herein. For example, machine readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a machine readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain machine readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain machine readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the machine readable medium is shown to be a single medium, the term “machine readable medium” includes a single medium or multiple media, such as a centralized or distributed database, and/or associated caches and servers that store one or more sets of machine-readable code instructions. The term “machine readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the machine readable medium can include a solid-state memory such as a memory card or other package that houses one or more non-volatile read-only memories. Further, the machine readable medium can be a random-access memory or other volatile re-writable memory. Additionally, the machine readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a machine readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may include a reconfigurable metasurface unit cell array 162. In an embodiment, the reconfigurable metasurface unit cell array 162 may be affixed to a display chassis cover of the laptop-type information handling system 100 such as the A-cover of a laptop type information handling system or the back of a tablet type information handling system. The A-cover may include a top portion of the lid of the laptop-type information handling system 100 housing an integrated digital display device 150, for example. The placement of the reconfigurable metasurface unit cell array 162 on the A-cover of the laptop-type information handling system 100 or the back of a tablet-type information handling system 100 may allow those electromagnetic fields (EMFs) generated by the EM waves of RF signals that are received and transmitted by the one or more antennas 140 of the information handling system 100 or from other devices within the RF environment to be controlled via directed reflection or reception of those RF signals in an RF environment.

In an embodiment, the reconfigurable metasurface unit cell array 162 may include a unique ID circuit 166. The unique ID circuit 166 may be any type of ranged tag such as a radio-frequency identification (RFID) or near-field communication (NFC) device that includes those devices that may allow the tag to be written to and read from using a unique ID circuit writer 180. Thus, the unique ID circuit writer 180 may be used by a third party, such as an administrator information handling system, to securely write data to the unique ID circuit 166 in order to provide wireless network access permission data at the reconfigurable metasurface unit cell array 162.

The wireless network access permission data may be provided, in an example embodiment, at a front desk or entrance to a building owned by the third party so that the third party may be able to control use of any SSIDs, frequencies, and/or frequency bands operating within a wireless network operated by the third party at that building or buildings. In this example, a user may be invited into the building owned by the third party and may carry the information handling system 100 into the building. The information handling system 100 owned by the user may include the reconfigurable metasurface unit cell array 162 formed into a housing of the information handling system 100 in an embodiment. In an alternative embodiment, the third-party owner of the building may provide a reconfigurable metasurface unit cell array 162 described herein to the user to affix the reconfigurable metasurface unit cell array 162 to the user's information handling system 100, at least, during the user's stay within the building. In either example, the reconfigurable metasurface unit cell array 162 described herein, may be used by the third party in order to selectively allow the user, via the operation of the information handling system 100, any access at all to managed portions of the wireless network in the third party's building as allowed by the wireless network access permission data provisioned by the third party owner of the building.

During operation, the unique ID circuit 166 may receive the wireless network access permission data at a metasurface hardware controller 172 of the reconfigurable metasurface unit cell array 162 via an antenna associated with a programmable RFID or NFC system. In an embodiment, the metasurface hardware controller 172 may execute machine readable code instructions of a network access ID management module 170. Execution of the machine readable code instructions of the network access ID management module 170 causes the metasurface hardware controller 172 to determine how to adjust each of the reconfigurable metasurface unit cells 164-1, 164-2, 164-3 to adjust reflection of incident radiofrequency signals transmitted from the information handling system 100 or received at the information handling system 100 to control available RF channels or bands at the information handling system. In addition, the wireless network access permission data may be transmitted to the wireless interface adapter 134 to establish allowed wireless access to portions of the third party wireless network or to designated wireless networks within the third party's RF environment.

In an embodiment, the metasurface hardware controller 172 may determine, based on the wireless network access permission data, that the reconfigurable metasurface unit cells 164-1, 164-2, 164-3 are to be reconfigured in such a way that prevents the wireless interface adapter 134 of the information handling system 100 to gain access to certain SSIDs and their wireless frequencies or channels used to communicate with that restricted SSID portion the wireless network 142, and/or frequency bands used to communicate with a particular wireless network 142 having a separate SSID. The metasurface hardware controller 172 may also, based on the received wireless network access permission data, allow for the wireless interface adapter 134 of the information handling system 100 to gain access to certain permitted SSIDs and limited to those wireless frequencies used to communicate within the permitted portion of the wireless network 142, and/or frequency bands used to communicate within the permitted wireless network 142 associated with only the permitted SSIDs. This allows the third-party operator of the provisioned wireless network 142 to provide specific wireless network access permission data that relegates each individual information handling system 100 within the RF environment to controlled and managed portions of the wireless network 142. In this way, an administrator information handling system may individualize each user's access to the wireless network 142 via limitations on access permitted for the user's wireless interface adapter 134 by controls implemented via the reconfigurable metasurface unit cell array 162. In an embodiment, an administrator of the wireless network 142 may create tiers of access to the wireless network 142 that have each been defined by specific wireless network access permission data in order to conveniently assign specific wireless network access permission data to specific information handling systems 100 operated by specific users within the wireless network 142. For example, a first tier may be a level 1 access tier for executives of a company, a level 2 access tier for employees of the company, and a level 3 access tier for other visitors such as guests. It is appreciated that the level of access to the SSIDs, frequencies, and/or frequency bands within the portions of the provisioned wireless network 142 may be significantly limited for guests, moderately limited for employees, and unlimited for executives.

It is appreciated that the metasurface hardware controller 172 determines, based on the wireless network access permission data and execution of the network access ID management module 170, how to reconfigure the reconfigurable metasurface unit cell array 162 in order to limit or allow access by the information handling system 100 to specific SSIDs, frequencies, and frequency bands, through use of the reconfigurable metasurface unit cell array 162. In an embodiment, the reconfigurable metasurface unit cell array 162 may include any type of reconfigurable metasurface unit cells 164-1, 164-2, 164-3. Thus, the examples of reconfigurable metasurface unit cells 164-1, 164-2, 164-3 described herein is meant only as an example, the present specification contemplates the use of other types of reconfigurable metasurface unit cells.

Thus, in an embodiment, the reconfigurable metasurface unit cell array 162 may include a plurality of reconfigurable metasurface unit cells 164-1, 164-2, 164-3, such as the first reconfigurable metasurface unit cell 164-1, a second reconfigurable metasurface unit cell 164-2, and a third reconfigurable metasurface unit cell 164-3 shown in FIG. 1. It is appreciated that the reconfigurable metasurface unit cell array 162 may contain any number of reconfigurable metasurface unit cells 164-1, 164-2, 164-3. In one example embodiment, the reconfigurable metasurface unit cell array 162 may contain two-hundred and fifty-six reconfigurable metasurface unit cells 164-1, 164-2, 164-3 arranged in a sixteen-by-sixteen array. It is appreciated that the reconfigurable metasurface unit cell array 162 may include any plurality of reconfigurable metasurface unit cells 164-1, 164-2, 164-3 in any arrangement of those reconfigurable metasurface unit cells 164-1, 164-2, 164-3. As described herein, the reconfigurable metasurface unit cells 164-1, 164-2, 164-3 within the reconfigurable metasurface unit cell array 162 may be used to, in real-time, reconfigure its reflective properties, such as phase-shift of reflected signals, to control the reflection, steering, and blocking of incoming EM waves from a transmitting source (e.g., the wireless antenna 140 of the wireless interface adapter 134 of the information handling system 100 or access points 144 and base stations 146 of the wireless network 142).

In an embodiment, the reconfigurable metasurface unit cell array 162 may further include an ultra wideband (UWB) circuit 168. In an embodiment, the UWB circuit 168 may be used by the metasurface hardware controller 172 to relay specific location data to one or more access points 144 or base stations 146 within the RF environment. In an embodiment, the operation of the UWB circuit 168 ensures centimeter-level precision in tracking the locations of the various information handling systems 100 thereby enabling real-time, context-aware control of wireless access to the wireless network 142 as users move their respective information handling systems 100 within the building and RF environment. In an embodiment, the metasurface hardware controller 172 may monitor for angle-of-arrival (AoA) of any given RF transmission relayed to the reconfigurable metasurface unit cell array 162 on the information handling system 100 in order to provide location data, via the reconfigurable metasurface unit cell array 162, to any access point 144, base station 146, or other network receiving device within the wireless network 142.

Thus, the presently-described reconfigurable metasurface unit cell array 126 of embodiments herein allows system administrators of a wireless network 142 and RF environment to remotely configure and reconfigure wireless access permissions at the reconfigurable metasurface unit cell arrays 126 thereby dynamically adjusting which SSIDs, frequencies, channels, or frequency bands are allowed or blocked at any specific information handling system 100 within the RF environment. In addition, the physical device may also be tracked using a UWB circuit allowing for precise location detection of the information handling system 100 within the RF environment and dynamic management of access to SSIDs of a portion of a provisioned wireless network 142 or different wireless networks 142 depending on location within an RF environment such as a building or campus.

As described herein, the reconfigurable metasurface unit cell array 162 may be operatively coupled to a metasurface PMU 174 and controlled via a metasurface hardware controller 172 that may be a hardware controller at the reconfigurable metasurface unit cell array 162. Like the PMU 128 of the information handling system 100, the metasurface PMU 174 may include control from the metasurface hardware controller 172. In an embodiment, the power needed to operate the reconfigurable metasurface unit cell array 162 may be low such that the metasurface battery 176 may be sufficient. In another embodiment, a metasurface A/C power adapter 178 may be used to power the metasurface hardware controller 172 and other components of the reconfigurable metasurface unit cell array 162.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

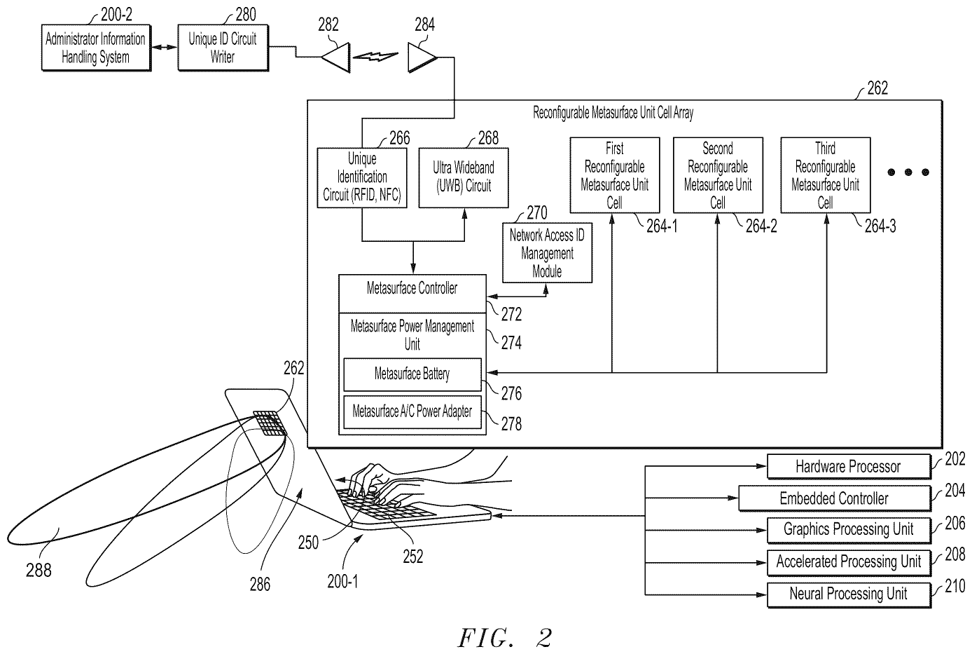

FIG. 2 is a block diagram illustrating an information handling system 200-1 including a unique ID circuit 266 with a metasurface hardware controller 272 executing machine readable code instructions of a network access ID management module 270 for dynamic wireless network access management with a reconfigurable metasurface unit cell array 262 according to another embodiment of the present disclosure. FIG. 2 shows the information handling system 200 as a laptop-type information handling system 200 that may include a digital display device 250 and a keyboard 252 as an output and input device, respectively. In this example embodiment, the information handling system 200-1 may be operated by a user with another administrator information handling system 200-2 being operated by an administrator of the wireless network for a radiofrequency environment such as a third-party owned premises. The information handling system 200-1 may be similar to the information handling system 100 of FIG. 1 and may include a hardware processor 202, embedded controller 204, graphics processing unit 206, accelerated processing unit 208, or neural processing unit 210 among other hardware processing devices according to embodiments herein. The laptop-type information handling system 200-1 may have the reconfigurable metasurface unit cell array 262 operatively coupled to the information handling system 200-1 on a surface of the display chassis lid portion or A-cover 286 of the information handling system 200-1 as in the shown embodiment or on another chassis portion of the information handling system 200-1. Alternatively, the reconfigurable metasurface unit cell array 262 may be placed on a surface of the chassis of the information handling system 200-1 next to one or more of the wireless antennas (e.g., FIG. 1, 140) used to wirelessly couple the information handling system 200-1 to the wireless network within the RF environment.

As described herein, the information handling system 200-1 operated by a user may include the reconfigurable metasurface unit cell array 262. Again, the reconfigurable metasurface unit cell array 262 may include a unique ID circuit 266. The unique ID circuit 166 may be any type of ranged tag such as a radio-frequency identification (RFID) or near-field communication (NFC) device that includes those devices that may allow the tag to be securely written to or read from using a unique ID circuit writer 280. Thus, the unique ID circuit writer 280 may be used by a third party to write data to the unique ID circuit 266 in order to provide wireless network access permission data at the reconfigurable metasurface unit cell array 262 and to a wireless interface adapter at the information handling system 200-1. During operation, the administrator operating the administrator information handling system 200-2 may also operate or cause the unique ID circuit writer 280 to transmit, via the unique ID writer antenna 282, this wireless network access permission data to the unique ID circuit 266, via a unique ID circuit antenna 284, causing the unique ID circuit writer 280 to wirelessly write the wireless network access permission data to the unique ID circuit 266. This transmission may be at an RFID or NFC protocol and require security authentications in some embodiments to provide for secure transmission of this wireless network access permission data.

The wireless network access permission data may be provided, in an example embodiment, at a front desk or entrance to a building owned by the third party so that the third party may be able to control use of any SSIDs, frequencies, and/or frequency bands operating within a wireless network operated by the third party at that building or buildings. In this example, a user may be invited into the building owned by the third party and may carry the information handling system 200-1 into the building. The information handling system 200-1 owned by the user may include the reconfigurable metasurface unit cell array 262 formed into a housing of the information handling system 200-1 in an embodiment. In an alternative embodiment, the third party such as the administrator operating the administrator information handling system 200-2 may provide a reconfigurable metasurface unit cell array 262 described herein to the user to affix the reconfigurable metasurface unit cell array 262 to the user's information handling system 200-1, at least, during the user's stay within the building. Prior to giving the reconfigurable metasurface unit cell array 262 to the user of the information handling system 200-1, the administrator may use the unique ID circuit writer 280 to upload or otherwise write the wireless network access permission data to the unique ID circuit 266, such as via a secure wireless communication, for use by the metasurface hardware controller 272 as described herein. In either example, the reconfigurable metasurface unit cell array 262 described herein, may be used by the third party in order to selectively allow the user to, via the operation of the information handling system 200-1, access allowed portions of the provisioned wireless network (e.g., operated and monitored by the administrator) as allowed by the wireless network access permission data provisioned by the administrator via a secured wireless link, such as by a writeable RFID or NFC wireless link.

During operation, the unique ID circuit 266 may receive the wireless network access permission data and a metasurface hardware controller 272 of the reconfigurable metasurface unit cell array 262, such as from a unique ID circuit writer 280 at an administrator information handling system 200-2. In an embodiment, the metasurface hardware controller 272 may execute machine readable code instructions of a network access ID management module 270. Execution of the machine readable code instructions of the network access ID management module 270 causes the metasurface hardware controller 272 to determine how to adjust each of the reconfigurable metasurface unit cells 264-1, 264-2, 264-3 to adjust reflection of incident radiofrequency signals transmitted from the information handling system 200-1 or received at the information handling system 200-1. Thus, in an embodiment, each of the reconfigurable metasurface unit cells 264-1, 264-2, 264-3 may be reconfigured to adjust a phase of a reflected EM wave off of the surface of the reconfigurable metasurface unit cell array 262. The phase shift of reflected EM waves across plural reconfigurable metasurface unit cells 264-1, 264-2, 264-3 may be used to create constructive or destructive interference patterns to generate directional beamformed lobe 288 of reflected EM waves to enhance gain and transmission or reception of RF signals with permitted portions of a wireless network with permitted SSIDs in an embodiment. Further, the phase shift of reflected EM waves across plural reconfigurable metasurface unit cells 264-1, 264-2, 264-3 may be used to create constructive or destructive interference patterns to generate null zones or reduced EM signal levels to prevent the transmission of restricted RF channels or RF bands of restricted SSIDs to or from the antenna (e.g., FIG. 1, 140) of the information handling system 200-1 using the reconfigurable metasurface unit cell array 262 in various embodiments. The blocking of the transmissions to or from the antenna of the information handling system 200-1 also allows the administrator to prevent the information handling system 200-1 from using specific SSIDs, frequencies, and frequency bands within the provisioned wireless network. As a consequence, the administrator operating the administrator information handling system 200-2 may provision each unique ID circuit 266 with specific wireless network access permission data that selectively prevents or allows certain information handling systems 200-1 to access specific SSIDs, frequencies, and frequency bands within the provisioned wireless network in a radiofrequency environment in order to dynamically manage access to the provisioned portions of the wireless network and remotely configure and even reconfigure wireless access permissions for each individual information handling system 200-1.

As the system and method described herein progresses, the metasurface hardware controller 272 may determine, based on the wireless network access permission data, that the reconfigurable metasurface unit cells 264-1, 264-2, 264-3 are to be reconfigured in such a way that prevents the wireless interface adapter (e.g., FIG. 1, 134) of the information handling system 200-1 to gain access to certain SSIDs, wireless frequencies used to communicate within the wireless network, and/or frequency bands used to communicate within the wireless network. As described herein, an administrator of the wireless network may create tiers of access to the wireless network that have each been defined by specific wireless network access permission data in order to conveniently assign specific wireless network access permission data to specific information handling systems 200-1 operated by specific users within the wireless network. For example, a first tier may be a level 1 access tier for executives of a company, a level 2 access tier for employees of the company, and a level 3 access tier for other visitors such as guests. It is appreciated that the level of access to the SSIDs, frequencies, and/or frequency bands within the wireless network may be significantly limited for guests, moderately limited for employees, and unlimited for executives. The administrator, operating the administrator information handling system 200-2, may be presented with a graphical user interface that allows the administrator to assign specific SSIDs, frequencies, or frequency bands to specific access tiers such that, as the administrator is operating the unique ID circuit writer 280 at an administrator information handling system 200-2, the administrator may simply select a specific access tier to be assigned and written, or securely transmitted, from each individual administrator information handling system 200-2 to the unique ID circuit 266 for the client information handling system 200-1.

It is appreciated that the metasurface hardware controller 272 determines, based on the wireless network access permission data during execution of the network access ID management module 270, how to reconfigure the reconfigurable metasurface unit cell array 262 in order to limit or allow access by the information handling system 200-1 to specific SSIDs, frequencies, and frequency bands, through use of the reconfigurable metasurface unit cell array 262. In an embodiment, the reconfigurable metasurface unit cell array 262 may include any type of reconfigurable metasurface unit cells 264-1, 264-2, 264-3. Thus, the examples of reconfigurable metasurface unit cells 264-1, 264-2, 264-3 described herein is meant only as an example, the present specification contemplates the use of other types of reconfigurable metasurface unit cells.

Thus, in an embodiment, the reconfigurable metasurface unit cell array 262 may include a plurality of reconfigurable metasurface unit cells 264-1, 264-2, 264-3, such as the first reconfigurable metasurface unit cell 264-1, a second reconfigurable metasurface unit cell 264-2, and a third reconfigurable metasurface unit cell 264-3 shown in FIG. 2. It is appreciated that the reconfigurable metasurface unit cell array 262 may contain any number of reconfigurable metasurface unit cells 264-1, 264-2, 264-3. It is appreciated that the reconfigurable metasurface unit cell array 262 may include any plurality of reconfigurable metasurface unit cells 264-1, 264-2, 264-3 in any arrangement of those reconfigurable metasurface unit cells 264-1, 264-2, 264-3. As described herein, the reconfigurable metasurface unit cells 264-1, 264-2, 264-3 within the reconfigurable metasurface unit cell array 262 may be used to, in real-time, reconfigure its reflective properties to control the reflection, steering, and blocking of incoming EM waves from a transmitting source.

In an embodiment, the reconfigurable metasurface unit cell array 262 may further include a UWB circuit 268. In an embodiment, the UWB circuit 268 may be used by the metasurface hardware controller 272 to relay specific location data to one or more access points or base stations, for example, within the RF environment. In an embodiment, the operation of the UWB circuit 268 ensures centimeter-level precision in tracking the locations of the various information handling systems 200-1 thereby enabling real-time, context-aware control of wireless access to the wireless network as users move their respective information handling system 200-1 within the building and RF environment. In an embodiment, the metasurface hardware controller 272 may monitor for angle of arrival (AoA) of any given RF transmission relayed to the reconfigurable metasurface unit cell array 262 on the information handling system 200-1 in order to provide location data, via the reconfigurable metasurface unit cell array 262, to any access point, base station, or other network receiving device within the wireless network to enhance directionality and gain of reflected RF signals by the reconfigurable metasurface unit cell array 262 or to implement RF signal suppression where appropriate in embodiments herein. It is appreciated that, in some embodiments, the UWB circuit 268 may also extend the reach of some transmissions, such as location transmissions, thereby adapting the reconfigurable metasurface unit cell array 262 to different scenarios within determined locations the RF environment/building while maintaining a relatively high level of control of the user's information handling system accessing the provisioned wireless network and the integrity of that provisioned wireless network by the administrator.

Thus, the presently-described reconfigurable metasurface unit cell array 226 of embodiments herein allows system administrators of a wireless network and RF environment to remotely configure and reconfigure wireless access permissions at the reconfigurable metasurface unit cell arrays 226 thereby dynamically adjusting which SSIDs, frequencies, channels, or frequency bands are allowed or blocked at any specific information handling system 200-1 within the RF environment via those reconfigurable metasurface unit cell arrays 226. This allows the administrator of the wireless network to effectively whitelist and blacklist certain SSIDs, frequencies, channels, and frequency bands available within the wireless network at any information handling system present within the RF environment.

In addition, the physical device may also be tracked using a UWB circuit 268 allowing for precise location detection of the information handling system 200-1 within the RF environment. The UWB circuit 268 in embodiments herein may include a radio system and controller to operate in accordance with a protocol such as IEEE 802.15.4z in an example embodiment. The UWB circuit 268 in embodiments herein may include a radio system and controller to transmit polling pulses in broad spectrum of wireless radiofrequencies to a plurality of anchor base stations or access points in an RF environment. Responses from the anchor base stations and access points are used to determine time or arrival, time difference of arrival, phase of arrival, angle of arrival, angle of departure, received signal strength indicator levels or channel state information among the plural response signals from known locations of anchor base stations or access points to accurately pinpoint a location of the UWB circuit 268 and the information handling system 200 within an RF environment. This location information may be at a centimeter level of precision and may be used for wireless network access management within particular location zones of a radiofrequency environment to make dynamic adjustments to a reconfigurable metasurface unit cell array 262 on an information handling system 200 based on received wireless network access permissions in embodiments herein.

Again, the reconfigurable metasurface unit cell array 262 may be operatively coupled to a metasurface PMU 274 and controlled via a metasurface hardware controller 272 that may be a hardware controller at the reconfigurable metasurface unit cell array 262. Like the PMU 228 of the information handling system 200-1, the metasurface PMU 274 may include control from the metasurface hardware controller 272. In an embodiment, the power needed to operate the reconfigurable metasurface unit cell array 262 may be low such that the metasurface battery 276 may be sufficient. In another embodiment, a metasurface A/C power adapter 278 may be used to power the metasurface hardware controller 272 and other components of the reconfigurable metasurface unit cell array 262.

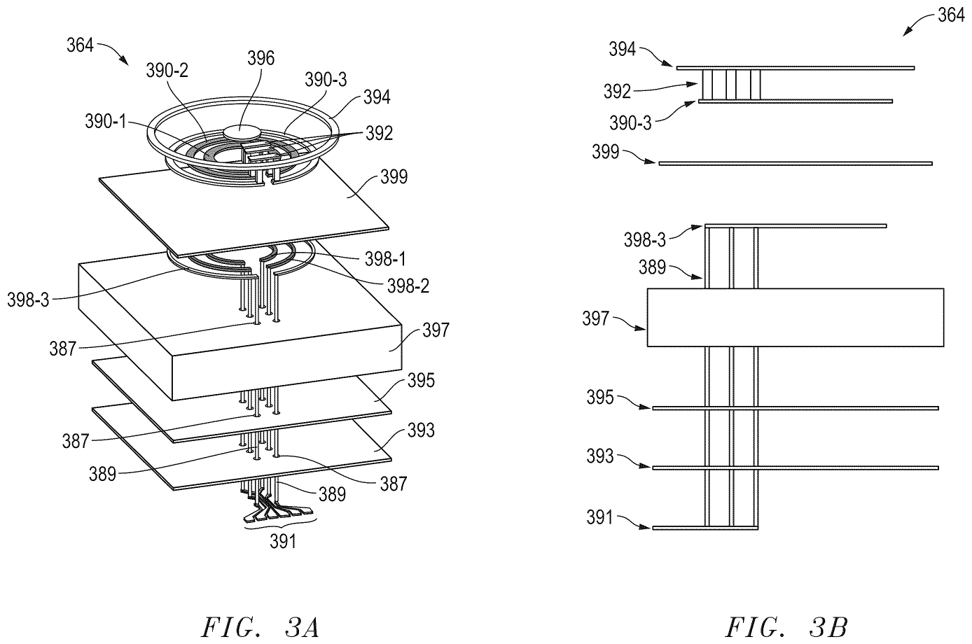

FIG. 3A is an exploded graphic diagram illustrating a perspective view of a reconfigurable metasurface unit cell 364 of a metasurface unit cell array according to an embodiment of the present disclosure. Additionally, FIG. 3B is a side, exploded graphic diagram illustrating a cross-section of a reconfigurable metasurface unit cell 364 of a metasurface unit cell array according to another embodiment of the present disclosure. It is appreciated that each of the reconfigurable metasurface unit cells 364 of the reconfigurable metasurface unit cell array may comprise their own various layers or may, in an embodiment, share the same layer or layers across a panel of the metasurface unit cell array. Again, the reconfigurable metasurface unit cell 364 shown in FIGS. 3A and 3B may be one of a plurality of reconfigurable metasurface unit cells 364 that form the reconfigurable metasurface unit cell array and may include any number of reconfigurable metasurface unit cells 364 arranged in any manner forming a two-dimensional panel structure or surface. As described herein, a plurality of reconfigurable unit cells 364 may operate together to engage in, at least, reflecting, blocking, accepting, beamforming, and transmitting/resonating EM waves of RF signals according to the wireless network access permission data received at the unique ID circuit and metasurface hardware controller as described herein. It is appreciated that the reconfigurable metasurface unit cells 364 shown in FIGS. 3A and 3B are merely examples of a reconfigurable metasurface unit cell and the present specification contemplates the use of other types of reconfigurable metasurface unit cells that may be used to selectively reflect, block, accept, beamform, and allow transmissions of RF frequencies associated with specific SSIDs and frequency bands pursuant to the received wireless network access permission data described herein. For example, reconfigurable metasurface unit cells may be used with passive resonant structures operatively coupled with tunable phase-shifting circuits, such as a tunable phase delay circuit or tunable varactor, via a microwave circuit that may be used to adjust phase-shifting of reflected or resonated RF signals across the metasurface unit cell array in some embodiments.

As shown in the embodiments of FIGS. 3A and 3B, the reconfigurable metasurface unit cell 364 includes concentrically formed first metasurface reconfigurable split ring 390-1, second metasurface reconfigurable split ring 390-2, and third metasurface reconfigurable split ring 390-3 formed on a first dielectric substrate layer 399 of the reconfigurable metasurface unit cell 364. Each of these metasurface reconfigurable split rings 390-1, 390-2, 390-3 may include any phase change materials such as GeTe, SbTe, or GeSbTe among other similar non-volatile phase change materials. One or more conductive bridges 392 may be formed at each metasurface reconfigurable split ring 390-1, 390-2, 390-3 to complete the split rings. The metasurface reconfigurable split rings 390-1, 390-2, 390-3 share the same layer as a non-reconfigurable metal fixed ring 394 and non-reconfigurable metal fixed center node 396 formed on the first dielectric substrate layer 399. In an embodiment, the non-reconfigurable metal fixed ring 394 may be arranged as an outer ring in some embodiments or another location in other embodiments. These metasurface reconfigurable split rings 390-1, 390-2, 390-3, the non-reconfigurable metal fixed ring 394, and non-reconfigurable metal fixed center node 396 act together to control and focus the directionality of the EM wave beams reflected off of the reconfigurable metasurface unit cell array as well as create destructive interference in order to prevent certain RF or frequency bands from being received at or transmitted from a specific information handling system (e.g., FIG. 2, 200-1). In an embodiment, the non-reconfigurable metal fixed ring 394 and non-reconfigurable metal fixed center node 396 may be made of a metal such as gold (Au), copper (Cu), aluminum (Al), nickel (Ni) among other types of conductive metals.

In an embodiment, each of the metasurface reconfigurable split rings 390-1, 390-2, 390-3 may include a split or gap along the circumference of the metasurface reconfigurable split ring 390-1, 390-2, 390-3. As shown in FIG. 3A, for example, this gap correlates with a gap in each of the respective refractory heaters 398-1, 398-2, 398-3 formed below the first layer formed by the metasurface reconfigurable split rings 390-1, 390-2, 390-3 and a first dielectric substrate layer 399. This enables operation of the refractory heaters 398-1, 398-2, 398-3 to pulse heat to the phase change material of the metasurface reconfigurable split rings 390-1, 390-2, 390-3 though the first dielectric substrate layer 399 which may be thermally conductive or otherwise permit heat transfer. In order to maintain the active beam steering and RF blocking capabilities of each of the metasurface reconfigurable split rings 390-1, 390-2, 390-3, this gap in each metasurface reconfigurable split rings 390-1, 390-2, 390-3 may be bridged using a conductive bridges 392. The conductive bridges 392 allows for induced currents in each of the metasurface reconfigurable split rings 390-1, 390-2, 390-3 to create or adjust radiated fields that form the controllable reflected wave patterns across the surface of the reconfigurable metasurface unit cell array described herein.

Below this first layer comprised of the metasurface reconfigurable split rings 390-1, 390-2, 390-3, the non-reconfigurable metal fixed ring 394, and the non-reconfigurable metal fixed center node 396, the reconfigurable metasurface unit cell 364 includes the first dielectric layer 399. This first dielectric layer 399 may be made of SiNx of AlN which may permit thermal conductivity. In an embodiment, this first dielectric layer 399 may include any insulating substance that does not conduct electricity but may also support electrostatic fields created during operation of the reconfigurable metasurface unit cell 364. Further, the first dielectric layer 399 may facilitate heat conduction between the refractory heaters 398-1, 398-2, 398-3 and the respective metasurface reconfigurable split rings 390-1, 390-2, 390-3.

Below the first dielectric layer 399, a second layer may be formed that comprises the first refractory heater 398-1, the second refractory heater 398-2, and the third refractory heater 398-3 in or on a second, main dielectric substrate 397. The refractory heaters 398-1, 398-2, 398-3 may each, individually and selectively, heat their respective metasurface reconfigurable split ring 390-1, 390-2, 390-3 with high intensity short duration pulses of heat. Thus, when a power source is applied to the first refractory heater 398-1, the first refractory heater 398-1 heats the first metasurface reconfigurable split ring 390-1. Additionally, when the power source is applied to the second refractory heater 398-2, the second refractory heater 398-2 heats the second metasurface reconfigurable split ring 390-2. Further, when a power source is applied to the third refractory heater 398-3, the third refractory heater 398-3 heats the third metasurface reconfigurable split ring 390-3. Thus, the conductive or dielectric states of each of the metasurface reconfigurable split rings 390-1, 390-2, 390-3 may be individually controlled via pulse heating of the individual refractory heaters 398-1, 398-2, 398-3 such that the states of the metasurface reconfigurable split rings 390-1, 390-2, 390-3 may be switched from their amorphous states to their crystalline states or vice versa.

It is appreciated that the voltage and current applied to each of the refractory heaters 398-1, 398-2, 398-3 controls the states of the metasurface reconfigurable split rings 390-1, 390-2, 390-3. For example, where the voltage applied to any of the refractory heaters 398-1, 398-2, 398-3 is high (e.g., 15-20 V) for a short period of time (e.g., up to 0.5 microseconds (μs)) with a peak current of 300 to 310 mA, the metasurface reconfigurable split rings 390-1, 390-2, 390-3 are placed in an amorphous state. This application of this voltage at this current creates a peak temperature at a metasurface reconfigurable split rings 390-1, 390-2, 390-3 of 700 to 800 °C. An average pulse power (W) may be initiated pulse heat to transition the phase change material the crystalline state at between 10⁰Ω 10¹Ω and to the amorphous state between 10⁵Ω 10⁶Ω in order to transition from a conductive state to the dielectric state in this example. However, where the voltage applied to any of the refractory heaters 398-1, 398-2, 398-3 is relatively lower (e.g., 9-10 V) for a relatively longer period of time (e.g., 2 μs) with a peak current of 210 to 220 mA the metasurface reconfigurable split rings 390-1, 390-2, 390-3 are switched back to a crystalline state in an embodiment. This application of this voltage and current creates a peak temperature at a metasurface reconfigurable split ring 390-1, 390-2, 390-3 of 400 to 410 °C. It is appreciated that heat pulses needed in order to place the non-volatile phase change material of the metasurface reconfigurable split ring 390-1, 390-2, 390-3 into an amorphous state or a crystalline state depends on the type of non-volatile phase change material used. Thus, the electrical pulse from the metasurface PMU (e.g., FIG. 2, 272) at an applied voltage and current to each of the refractory heaters 398-1, 398-2, 398-3 to change the state of the non-volatile phase change material of each metasurface reconfigurable split ring 390-1, 390-2, 390-3 may depend on the type of non-volatile phase change material used. The present specification contemplates that any of a plurality of non-volatile phase change materials may be used necessitating changes in these applied voltages and currents.

Other layers and substrates may also be included in the stack within the reconfigurable metasurface unit cell 364. In an example embodiment, the reconfigurable metasurface unit cell 364 may further include the second, main electrical dielectric substrate 397 placed below the second layer that comprises the refractory heaters 398-1, 398-2, 398-3. This electrical dielectric substrate 397 may be made of a HRSi, Al₂O₃, glass, or PCB among other dielectric materials that is thermally insulative. In an embodiment, the first dielectric layer 399 and electrical dielectric substrate 397 may electrically isolate the refractory heaters 398-1, 398-2, 398-3 while the second electrical dielectric substrate 397 may thermally isolate the refractory heaters 398-1, 398-2, 398-3 from the remaining portions of the reconfigurable metasurface unit cell 364.

In an embodiment, a mentalization layer 395 may be formed below the electrical dielectric substrate 397. This mentalization layer 395 may be made of Au, Cu, Al, or Ni among other types of metals. In an embodiment, this mentalization layer 395 may serve as an RF grounding source for the reconfigurable metasurface unit cell 364.

In an embodiment, an additional dielectric layer 393 may be placed below the mentalization layer 395. This third dielectric layer 393 may be made of silicon dioxide (SiO₂). Similar to the first dielectric layer 399, the second dielectric layer 393 may also support electrostatic fields created during the operation of the unit cell 364. In other embodiments, the second dielectric layer 393 may have limited thermal conductivity.

Below the additional, third dielectric layer 393, contact pads 391 used to address by electrical coupling of the refractory heaters 398-1, 398-2, 398-3 to a metasurface PMU (e.g., FIG. 1, 172) is shown. The contact pads 391 may be made of any conductive metal such as Au, Cu, Al, or Ni among other types of metals. The contact pads 391 may receive those electrical pulses from the metasurface PMU in order to pulse heat, individually, each of the refractory heaters 398-1, 398-2, 398-3. In order to operatively couple each of the refractory heaters 398-1, 398-2, 398-3 to a respective contact pad 391, a plurality of metal interconnect rods 389 are formed. In the example embodiment shown in FIGS. 3A and 3B, the metal interconnect rods 389 couple a contact pad 391 to each terminal end of each of the refractory heaters 398-1, 398-2, 398-3. In order to do so, one or more vias 387 are formed through, at least, the lower additional dielectric layer 393, the mentalization layer 395, and the main electrical dielectric substrate 397 so that the metal interconnect rods 389 may pass from each of the respective contact pads 391 to their respective refractory heaters 398-1, 398-2, 398-3.

FIGS. 3A and 3B show a single reconfigurable metasurface unit cell 364 among a plurality of reconfigurable metasurface unit cells 364 that may form the reconfigurable metasurface unit cell array described herein. It is appreciated that the reconfigurable metasurface unit cell array may comprise any number of individually activatable reconfigurable metasurface unit cells 364. In one example embodiment, the reconfigurable metasurface unit cell array may place the reconfigurable metasurface unit cells 364 in a row and column orientation thereby forming, for example, a sixteen-by-sixteen reconfigurable metasurface unit cell array. During operation, as described herein, each refractory heaters 398-1, 398-2, 398-3 are individually heated using the contact pads 391 such that each of the metasurface reconfigurable split rings 390-1, 390-2, 390-3, individually, undergo a phase change into an amorphous state or a crystalline state thereby changing the EM wave reflective properties of each individual unit cells 364 and allowing plural EM wave directions to be controlled with the reconfigurable metasurface unit cells 364 in the array. By selectively changing the individual EM wave reflective properties of each individual unit cell 364, the reconfigurable metasurface unit cell array may also change the directionality and feed distance of the reflected EM wave, prevent reception and transmission of certain SSIDs or radio frequencies such that the reconfigurable metasurface unit cell array may reflect, block, accept, beamform, and allow transmission of EM waves according to the wireless network access permission data received at the unique identification circuit (e.g., FIG. 2, 266). Because of the EM wave-reflective properties of the reconfigurable metasurface unit cell array may be changed readily (e.g., in the order of microseconds or nanoseconds), a single reconfigurable metasurface unit cell array may be reconfigured to relay data in radiofrequency signals via these EM waves to multiple receiving devices.

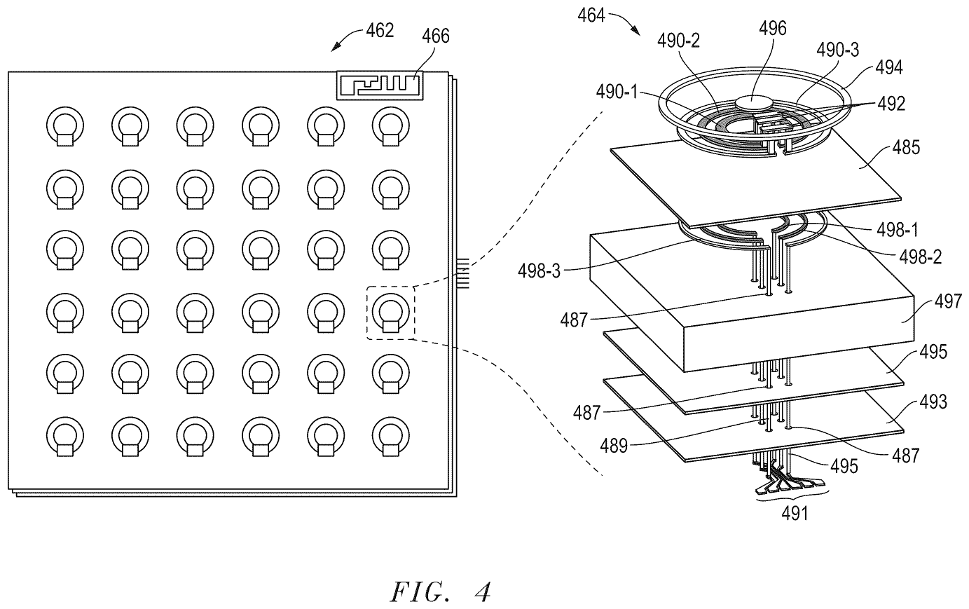

FIG. 4 is a top view graphic diagram showing a reconfigurable metasurface unit cell array 462 including a unique ID circuit 466 and an exploded perspective view graphic diagram showing a reconfigurable metasurface unit cell 464 according to an embodiment of the present disclosure. The reconfigurable metasurface unit cell array 462 shown in FIG. 4 may be similar to that reconfigurable metasurface unit cell array shown and described in FIGS. 1 and 2.

Those elements of the reconfigurable metasurface unit cell 464 may include similar elements to those shown in, for example, FIGS. 3A and 3B. As such the reconfigurable metasurface unit cell 464 may include a plurality of metasurface reconfigurable split rings 490-1, 490-2, 490-3 that are heated by a commensurate plurality of refractory heaters 498-1, 498-2, 498-3 to change the phase change material from a conductive material phase to a dielectric material phase as described herein. In order to provide power to the refractory heaters 498-1, 498-2, 498-3 to conduct this heating process, the reconfigurable metasurface unit cell 464 may further include contact pads 491 operatively coupling a metasurface PMU to the refractory heaters 498-1, 498-2, 498-3 via one or more metal interconnect rods 489. A first dielectric layer 499, a main electrical dielectric substrate 497, and an additional dielectric layer 493 may be used to electrically isolate, at least, the refractory heaters 498-1, 498-2, 498-3, metasurface reconfigurable split rings 490-1, 490-2, 490-3, and contact pads 491 from each other. A mentalization layer 495 may be formed below the electrical dielectric substrate 497 to serve as an RF grounding source for the reconfigurable metasurface unit cell 464.

As described herein, the unique ID circuit 466 may be formed onto a surface of the reconfigurable metasurface unit cell array 462 and may be operatively coupled to the metasurface hardware controller (e.g., FIG. 2, 272) which may include a microcontroller unit or other hardware processor. As described herein, a unique ID circuit 466 may receive, wirelessly via writeable RFID or NFC protocols for example, the wireless network access permission data to the unique ID circuit 466 for processing by the metasurface hardware controller. Thus, the unique ID circuit 466 may include an antenna and radio system as well, such as for receiving or transmitting writeable RFID or NFC secure communications. In further embodiments, unique ID circuit 466 or elsewhere on the metasurface unit cell array 462 may include the UWB circuit (e.g., 268 of FIG. 2) including antennas and UWB radio system or controller to poll UWB anchor access points for precise location determination of the metasurface unit cell array 462.

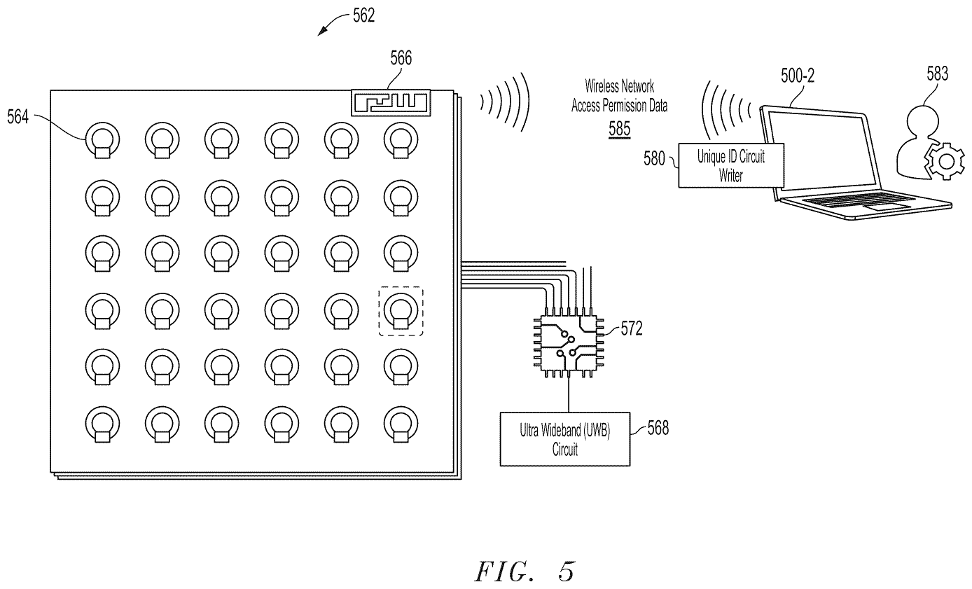

FIG. 5 is a top view graphic diagram showing a reconfigurable metasurface unit cell array 562 including a unique ID circuit 566 and an ultra-wideband (UWB) circuit interfacing with an administrator information handling system 500-2 according to an embodiment of the present disclosure. The reconfigurable metasurface unit cell array 562 shown in FIG. 5 may be similar to that reconfigurable metasurface unit cell array shown and described in FIGS. 1 and 2. Those elements of the reconfigurable metasurface unit cell 564 may include similar elements to those shown in, for example, FIGS. 3A and 3B, or other types of reconfigurable metasurface unit cells 564, such as having tunable phase-shifting circuits for example, according to other embodiments.

According to embodiments of the present disclosure, the unique ID circuit 566 may be formed onto a surface of the reconfigurable metasurface unit cell array 562 and may be operatively coupled to the metasurface hardware controller 572 which may include a microcontroller unit or other hardware processor on the reconfigurable metasurface unit cell array 562. As described herein, a unique ID circuit 566 may receive, wirelessly via writeable RFID or NFC protocols for example, the wireless network access permission data to the unique ID circuit 566 for processing by the metasurface hardware controller 572. Thus, the unique ID circuit 566 may include an antenna and radio system as well, such as for receiving or transmitting writeable RFID or NFC secure communications. In further embodiments, unique ID circuit 566 or elsewhere on the metasurface unit cell array 562 may include or have a separate the UWB circuit 568 onboard including antennas and a UWB radio system or controller to poll UWB anchor access points in its RF environment for precise location determination of the metasurface unit cell array 562.

As described herein, the unique ID circuit writer 580 may be used by an administrator 583 to write the wireless network access permission data 585, via secure communication, to the unique ID circuit 566 in order to provide this wireless network access permission data 585 at the reconfigurable metasurface unit cell array 562. During operation, the administrator 583 operating the administrator information handling system 500-2 (e.g., similar to 200-2 in FIG. 2) may also operate or cause the unique ID circuit writer 580 to transmit this wireless network access permission data 585, such as via writable RFID or NFC secure protocol, to the unique ID circuit 566. During operation, the unique ID circuit writer 80 may, via a wireless coupling to the unique ID circuit 566, write the wireless network access permission data 585 to the unique ID circuit 566 in various embodiments herein.

The unique ID circuit 566 may receive the wireless network access permission data 585 and provide the same to a metasurface hardware controller 572 of the reconfigurable metasurface unit cell array 562 as well as a wireless interface adapter at the client information handling system being brought to operate within the RF environment and provisioned wireless network or networks therein. In an embodiment, the metasurface hardware controller 572 may execute machine readable code instructions of a network access ID management module (e.g., FIG. 2, 270).

Execution of the machine readable code instructions of the network access ID management module causes the metasurface hardware controller 572 determines how to adjust each of the reconfigurable metasurface unit cells 564 to adjust reflection of incident radiofrequency signals transmitted from the client information handling system or received at the client information handling system for various portions of the provisioned wireless network or wireless networks. Thus, in an embodiment, each of the reconfigurable metasurface unit cells 564 may be reconfigured to adjust a phase of a reflected EM wave off of an RF signal of each reconfigurable metasurface unit cell 564 across the surface of the reconfigurable metasurface unit cell array 562. The phase shift of reflected EM waves across plural reconfigurable metasurface unit cells 564 may be used to create constructive or destructive interference patterns to generate directional beamformed lobe of reflected EM waves for enhanced directionality or gain for permitted RF channels or bands to SSIDs of the partitioned wireless network for which wireless network access permission data 585 contain wireless network permissions. The phase shift of reflected EM waves across plural reconfigurable metasurface unit cells 564 may also be used to create constructive or destructive interference patterns to generate to null zones or signal suppression to prevent the transmission to or from the antenna (e.g., FIG. 1, 140) of the information handling system using the reconfigurable metasurface unit cell array 562 for restricted RF channels or bands used by SSIDs of portions of the partitioned wireless network for which wireless network access permission data 585 excludes wireless access in various embodiments. The blocking of the transmissions to or from the antenna of the information handling system also allows the administrator 583 to prevent the information handling system from using specific SSIDs, frequencies, and frequency bands within the provisioned wireless network. As a consequence, the administrator 583, operating the administrator information handling system 500-2, may provision each unique ID circuit 566 with specific wireless network access permission data that selectively prevents or allows certain information handling systems to access specific SSIDs, frequencies, and frequency bands within the wireless network in order to better manage access to various portions of the provisioned wireless network and remotely configure and even reconfigure wireless access permissions for each client individual information handling system operating in the RF environment.

In an embodiment, the reconfigurable metasurface unit cell array 562 may further include a UWB circuit 568. In an embodiment, the UWB circuit 568 include UWB antennas and operate with a hardware controller, such as metasurface hardware controller 572 or another controller, to detect and relay specific location data to one or more access points or base stations, for example, within the RF environment. The UWB circuit 568 in embodiments herein may include a radio system and controller to operate in accordance with a protocol such as IEEE 802.15.4z in an example embodiment. The UWB antennas are used to poll and receive broadband signals to determine time or arrival, time difference of arrival, phase of arrival, angle of arrival, angle of departure, received signal strength indicator levels or channel state information among the plural response signals from known locations of anchors base stations or access points based on detection and response from plural UWB anchor access points or base stations in the RF environment in embodiments herein. With this data, the UWB circuit accurately pinpoints a location of the UWB circuit 568 and the reconfigurable metasurface unit cell array 562 of the client information handling system.

In an embodiment, the operation of the UWB circuit 568 ensures centimeter-level precision in tracking the locations of the various information handling systems thereby enabling real-time, context-aware control of wireless access to the wireless network as users move their respective information handling system within a building and/or RF environment. In an embodiment, the metasurface hardware controller 572 may monitor location determined via the UWB circuit 568 to adjust the reconfigurable metasurface unit cell array 562 on the information handling system in order to provide dynamic wireless network access adjustments. The dynamic wireless network access adjustments may change based on reported location data as determined by the metasurface hardware controller 572 execution of machine readable code instructions of the network access ID management module from the wireless network access permission data 585 in embodiments herein.

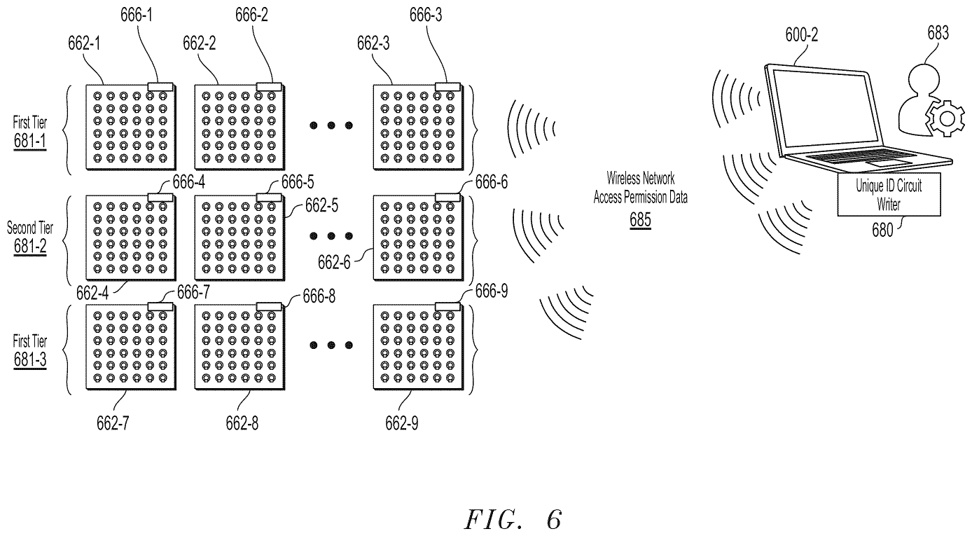

FIG. 6 is a graphic diagram showing a plurality of reconfigurable metasurface unit cell arrays 662-1 through 662-9 in a radiofrequency environment that each include a unique ID circuit 666-1 through 666-9 interfacing with an administrator 683 operating an information handling system 600-2 according to an embodiment of the present disclosure. Again, the administrator 683 may be operating an information handling system 600-2 similar to that shown and described in FIG. 2 or FIG. 4 that includes a unique ID circuit writer 680. The unique ID circuit writer 680 may be used by the administrator 683 and information handling system 600-2 to securely write data to the unique ID circuits 666-1 through 666-9 at each of the individual reconfigurable metasurface unit cell arrays 662-1 through 662-9 in order to provide tiered wireless network access permission data 685 at each of the reconfigurable metasurface unit cell arrays 662-1 through 662-9.

FIG. 6 shows that the sets of wireless network access permission data 685 may be transmitted to individual reconfigurable metasurface unit cell arrays 662-1 through 662-9 that have been arranged within a first tier 681-1, a second tier 681-2, and a third tier 681-3 and may access SSIDs, radio frequencies, and frequency bands that are specific to the three partitioned tiers of the provisioned wireless network. It is appreciated that more that the three tiers 681-, 681-2, 681-3 may be created that each include specific restrictions and allowances to SSIDs, radio frequencies, and frequency bands that each of the reconfigurable metasurface unit cell arrays 662-1 through 662-9 and their operatively-coupled information handling systems may have access to that are present within the provisioned wireless network partitioned into the plural tiers.

As described herein, an administrator 683 of the wireless network may create these tiers 681-, 681-2, 681-3 of access to the wireless network that have each been defined by specific wireless network access permission data 685 in order to conveniently assign specific wireless network access permission data 685 to specific reconfigurable metasurface unit cell arrays 662-1 through 662-9 of specific information handling systems operated by specific users within the wireless network. For example, the first tier 681-1 may be a level 1 access tier for executives of a company, the second tier 681-2 may be a level 2 access tier for employees of the company, and the third tier 681-3 may be a level 3 access tier for other visitors such as guests. It is appreciated that the level of access to the SSIDs, frequencies, and/or frequency bands within the wireless network may be significantly limited for guests, moderately limited for employees, and unlimited for executives. The administrator 683, operating the administrator information handling system 600-2, may be presented with a graphical user interface that allows the administrator 683 to assign specific SSIDs, frequencies, or frequency bands to specific access tiers. This allows the administrator 683 to operate the unique ID circuit writer 680 by selecting a specific access tier 681-, 681-2, 681-3 to be associated with each individual information handling system unique ID circuit 666-1 through 666-9.

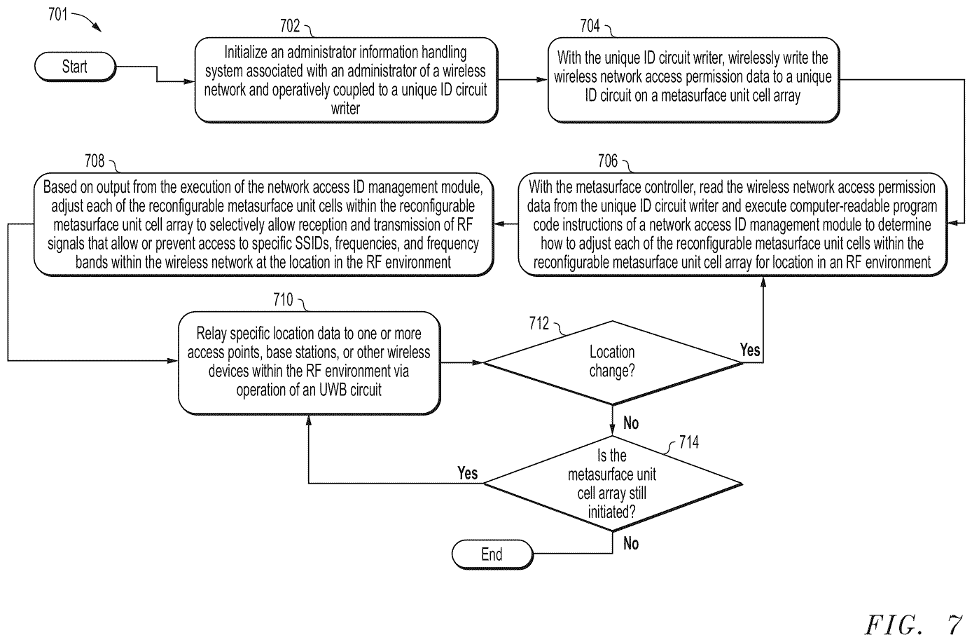

FIG. 7 is a flow diagram of a method 701 of monitoring wireless network access within a radiofrequency (RF) environment by information handling systems having metasurface unit cell arrays including a unique ID circuit and an ultra-wideband (UWB) circuit according to another embodiment of the present disclosure. The reconfigurable metasurface unit cell array used in this method may be similar to those reconfigurable metasurface unit cell arrays described in connection with, for example, FIGS. 1, 2, and 4-6. The reconfigurable metasurface unit cell arrays may include a plurality of reconfigurable metasurface unit cells as described in connection with FIGS. 3A and 3B or any other types of reconfigurable metasurface unit cells that are addressable and adjustable for phase shift in reflection, absorption, and transmission of incident EM waves of radiofrequency signals from within the RF environment and transmitted from or to the client information handling system of embodiments herein. The reconfigurable metasurface unit cell array may include a plurality of reconfigurable metasurface unit cells that are individually controlled via a metasurface hardware controller and using a metasurface PMU or other power source as well as other components to adjust phase shifting of reflected EM waves by resonant structures on the reconfigurable metasurface unit cells as described in embodiments herein.

At block 702, an administrator information handling system associated with the administrator may be initialized. The administrator, in an embodiment, may initialize the administrator information handling system by actuating a button that provides power to a hardware processor of the information handling system. In an embodiment, this administrator information handling system operated by the administrator may also be coupled to a unique ID circuit writer that is used by the administrator to write data to a unique ID circuit of a reconfigurable metasurface unit cell array associated with a client information handling system operated by a user. This is done to, in the embodiments described herein, provide wireless network access permission data at the reconfigurable metasurface unit cell array.

At block 704, the system and method may provide for the administrator operating the administrator information handling system to operate or cause the unique ID circuit writer to transmit, via a secure unique ID writer antenna on the administrator information handling system, this wireless network access permission data to the unique ID circuit, via a unique ID circuit antenna on the reconfigurable metasurface unit cell, causing the unique ID circuit writer to wirelessly write the wireless network access permission data to the unique ID circuit. In example embodiments, the secure unique ID writer antenna on the administrator information handling system and the unique ID circuit antenna on the reconfigurable metasurface unit cell may operate via writable RFID or NFC wireless communication protocols to securely transfer this wireless network access permission data to the unique ID circuit via a secure short range wireless link.

As described herein, the wireless network access permission data may be provided, in an example embodiment, at a front desk or entrance to a building owned by a third party in which the administrator of the wireless network is operation. This allows the administrator to control access to any SSIDs, frequencies, and/or frequency bands operating within a wireless network operated by the administrator at that building or buildings using the unique ID circuit associated with each of the reconfigurable metasurface unit cell arrays for each of the client information handling systems of distinct users entering the building. In this example, a user may be invited into the building and may carry the user's information handling system into the building. The information handling system may include the reconfigurable metasurface unit cell array formed into a housing of the information handling system in an embodiment. In an alternative embodiment, the administrator operating the administrator information handling system may provide a reconfigurable metasurface unit cell array described herein to the user to affix the reconfigurable metasurface unit cell array to the user's information handling system. The reconfigurable metasurface unit cell array may remain on the user's information handling system, at least, during the user's stay within the building. Prior to giving the reconfigurable metasurface unit cell array to the user of the information handling system or as the embedded reconfigurable metasurface unit cell array of the user's information handling system passes by the unique ID circuit writer, the administrator may use the unique ID circuit writer to upload or otherwise write the wireless network access permission data to the unique ID circuit of the reconfigurable metasurface unit cell array for use by the metasurface hardware controller at block 704. In either example, the reconfigurable metasurface unit cell array described herein, may be used by the administrator in order to selectively allow the user to, via the operation of the information handling system, provisioned access, such as in one of a plurality of tiers, to the wireless network as allowed by the wireless network access permission data provisioned by the administrator wirelessly from the unique ID circuit writer.

At block 706, the method 701 includes the metasurface hardware controller of the reconfigurable metasurface unit cell array reading the wireless network access permission data and executing machine readable code instructions of a network access ID management module. Execution of the machine readable code instructions of the network access ID management module causes the metasurface hardware controller from the assigned tier in the wireless network access permission data to determine how to adjust each of the reconfigurable metasurface unit cells within the reconfigurable metasurface unit cell array in order to adjust reflection of incident radiofrequency signals transmitted from the information handling system or received at the information handling system. As described in some embodiments herein, the wireless network access permission data may be dynamic and change based on detected location of the client information handling system and reconfigurable metasurface unit cell array within the radiofrequency environment. In other words, detection of location via a UWB circuit at the reconfigurable metasurface unit cell array may determine the network access permissions or tiers assigned to a client information handling system for portions of the partitioned wireless network at that location.

As described herein, each of the reconfigurable metasurface unit cells may be reconfigured to adjust a phase of a reflected EM wave off of the surface of the reconfigurable metasurface unit cell array. The phase shift of reflected EM waves across plural reconfigurable metasurface unit cells may be used to create constructive or destructive interference patterns to generate directional beamformed lobe of reflected EM waves or to prevent the RF signal transmission to or from the antenna (e.g., FIG. 1, 140) of the information handling system using the reconfigurable metasurface unit cell array. The blocking of the transmissions to or from the antenna of the information handling system, for example, may also allow the administrator to restrict the client information handling system from using specific SSIDs, frequencies, and frequency bands within the wireless network. As a consequence, the administrator operating the administrator information handling system may provision each unique ID circuit with specific wireless network access permission data that selectively prevents or allows certain information handling systems to access specific SSIDs, frequencies, and frequency bands within the wireless network in order to better manage the wireless network and remotely configure and even reconfigure wireless access permissions for each individual information handling system.

Therefore, at block 708, the method 701 further includes, based on output from the execution of the network access ID management module, the metasurface hardware controller adjusting each of the reconfigurable metasurface unit cells within the reconfigurable metasurface unit cell array to selectively allow reception and transmission of RF signals that allow or prevent access to specific SSIDs, frequencies, and frequency bands within the wireless network. As described in some embodiments herein, the wireless network access permission data may be dynamic and change based on detected location of the client information handling system and reconfigurable metasurface unit cell array within the radiofrequency environment, such as with the UWB circuit at the reconfigurable metasurface unit cell array. This may be done by turning off metasurface unit cells, activating metasurface unit cells, or adjusting metasurface unit cells to adjust phase-shifted interference profiles across the metasurface unit cell array to generate null zones for restricted frequencies or frequency bands of restricted SSID portions of the wireless network in an embodiment. Further, the metasurface hardware controller may also enhance reflected RF signals for permitted frequencies or frequency bands of allowed SSID portions of the wireless network via turning off metasurface unit cells, activating metasurface unit cells, or adjusting metasurface unit cells to adjust phase-shifted interference profiles across the metasurface unit cell array to generate directionality lobes with enhanced gain. These adjustments may dynamically change as the location changes to alter the network access permissions or tiers assigned to a client information handling system for portions of the partitioned wireless network at that location in embodiments herein. As described herein, the reconfigurable metasurface unit cells may include any type of reconfigurable metasurface unit cells according to various embodiments, such as example reconfigurable metasurface unit cell embodiments described herein.

At block 710, the method 701 may include relaying specific location data to one or more access points, base stations, or other wireless devices within the RF environment via operation of a UWB circuit with broadband antenna polling plural UWB anchor access points within an RF environment according to embodiments herein. In an embodiment, the operation of the UWB circuit ensures centimeter-level precision in tracking the locations of the various information handling systems thereby enabling real-time, context-aware control of wireless access to the wireless network as users move their respective information handling systems within the building and RF environment. In an embodiment, the metasurface hardware controller may pulse broadband signals to monitor for time or arrival, time difference of arrival, phase of arrival, angle of arrival, angle of departure, received signal strength indicator levels or channel state information among the plural response signals from known locations of anchor base stations or access points to accurately pinpoint a location of the UWB circuit and the client information handling system within an RF environment. This provides for location data of the reconfigurable metasurface unit cell array on the information handling system to the metasurface hardware controller executing machine readable code instructions of the network access ID management module to apply the tier restrictions of the tier assigned within the wireless network access permission data received at the unique identification circuit.

Proceeding to block 712, the metasurface hardware controller executing machine readable code instructions of the network access ID management module determines if the location has changed and whether a new tier restriction should apply based on the wireless network access permission data received at the unique identification circuit. If no new location is detected that changes the tier classification for the client information handling system, the method proceeds to block 714. If a new location is detected that changes the tier classification for the client information handling system, the method returns to block 706 to implement adjustments to the reconfigurable metasurface unit cell array as described herein.

At block 714, the method 701 includes determining if the reconfigurable metasurface unit cell array is still initiated. Where the reconfigurable metasurface unit cell array is still initiated, the method 701 returns to block 710 with the UWB circuit continuing to provide real-time location data as described herein. Where the reconfigurable metasurface unit cell array is no longer initiated, the method 701 may end here.

The processes or steps and aspects of the operation of the embodiments herein, such as in FIG. 7, or others discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor, a memory device, a wireless interface adapter, and a power management unit (PMU) to provide power to the hardware processor, the memory device, and the wireless interface adapter to transceive wireless network data within a radiofrequency (RF) environment;
a reconfigurable metasurface unit cell array operatively coupled to a chassis surface of the information handling system to manipulate electromagnetic (EM) waves of incident radiofrequency signals transmitted or received by plural radiofrequency (RF) antennas on the information handling system, wherein the reconfigurable metasurface unit cell array includes a plurality of reconfigurable metasurface unit cells to adjust reflection of incident radiofrequency signals;
a unique identification (ID) circuit formed on the reconfigurable metasurface unit cell array to receive, from a unique ID circuit writer at an administrator information handling system, wireless network access permission data describing accessibility to partitioned wireless connections in a provisioned wireless network; and
a metasurface hardware controller to execute machine readable program code instructions of a network access ID management module to receive the wireless network access permission data and adjust the reconfigurable metasurface unit cells to create phase-shifted interference patterns to adjust reflection of incident radiofrequency signals transmitted from the information handling system or received at the information handling system to suppress reflection of RF signals for wireless links with restricted partitioned wireless connections of the provisioned wireless network.

2. The information handling system of claim 1 further comprising:
the metasurface hardware controller to execute machine readable program code instructions of the network access ID management module to receive the wireless network access permission data and adjust the reconfigurable metasurface unit cells to create phase-shifted interference patterns to adjust reflection of incident radiofrequency signals transmitted from the information handling system or received at the information handling system to beamform directionality and gain for reflection of RF signals for wireless links with permitted partitioned wireless connections of the provisioned wireless network.

3. The information handling system of claim 1 further comprising:
the reconfigurable metasurface unit cells each including a set of resonant structures to receive and reflect the incident radiofrequency signals and operatively coupled to a tunable phase-shifting circuit to phase-shift reflected RF signals at those reconfigurable metasurface unit cells.

4. The information handling system of claim 1 further comprising:
the reconfigurable metasurface unit cells including a set of concentric resonant structures and a metal fixed tab formed within the concentric resonant structures, where a subset of the concentric resonant structures have reconfigurable conductive and dielectric states to phase-shift reflected RF signals at those reconfigurable metasurface unit cells.

5. The information handling system of claim 1 further comprising:
a plurality of reconfigurable metasurface unit cells formed with a set of concentric resonant structures including a subset of concentric resonant structures having one or more phase change material resonant structures made of a phase change material that, when heated by a refractory heater, switches between conductive material phase to a dielectric material phase to adjust reflection phase-shift of the reflected RF signal.

6. The information handling system of claim 5 further comprising:
the metasurface hardware controller to adjust each reconfigurable metasurface unit cell with power supplied to contact pads to operatively couple a refractory heater to a metasurface power source controlled by the metasurface hardware controller to provide power to the first refractory heater to provide a heat pulse to the at least one of the phase change material concentric resonant structures made of the phase change material to adjust a phase shift of the reflected radiofrequency signal at the reconfigurable metasurface unit cell.

7. The information handling system of claim 1 further comprising:
an ultrawide band (UWB) circuit and antenna on the reconfigurable metasurface unit cell array to pulse broadband signals to plural access points in the radiofrequency environment to determine a location of the information handling system within the radiofrequency environment; and
the metasurface hardware controller to execute machine readable program code instructions of a network access ID management module to adjust the reconfigurable metasurface unit cells to create phase-shifted interference patterns to adjust reflection of incident radiofrequency signals transmitted from the information handling system or received at the information handling system based on the wireless network access permission data for the newly detected location of the information handling system.

8. The information handling system of claim 1, wherein the network access permission data describing accessibility to wireless connections to a wireless network includes data defining a plurality of different accessibility levels to partitioned wireless connections in a provisioned wireless network for plural physical locations within an RF environment of a physical building.

9. A method of dynamic wireless network access management of an information handling system with a reconfigurable metasurface unit cell array comprising:
receiving, at a unique identification (ID) circuit on the reconfigurable metasurface unit cell array operatively coupled to a chassis surface of the information handling system, wireless network access permission data describing accessibility to wireless connections to partitioned wireless connections in a provisioned wireless network;
executing machine readable program code instructions, via a metasurface hardware controller, of a network access ID management module to receive the wireless network access permission data and adjust the reconfigurable metasurface unit cells to create phase-shifted interference patterns to adjust reflection of incident radiofrequency signals transmitted from the information handling system or received at the information handling system to suppress reflection of RF signals for wireless links with restricted partitioned wireless connections of the provisioned wireless network; and
reflecting incident radiofrequency signals transmitted or received by plural radiofrequency (RF) antennas on the information handling system with the reconfigurable metasurface unit cell array at a radiofrequency channel to access permitted partitioned wireless connections of the provisioned wireless network as determined by the network access ID management module from the wireless network access permission data, wherein the reconfigurable metasurface unit cell array includes a plurality of reconfigurable metasurface unit cells to adjust reflection of incident radiofrequency signals.

10. The method of claim 9 further comprising:
executing machine readable program code instructions, via the metasurface hardware controller, of the network access ID management module to receive the wireless network access permission data and adjust the reconfigurable metasurface unit cells to create phase-shifted interference patterns to adjust reflection of incident radiofrequency signals transmitted from the information handling system or received at the information handling system to beamform directionality and gain for reflection of RF signals for wireless links at the radiofrequency channel to access permitted partitioned wireless connections of the provisioned wireless network.

11. The method of claim 9, wherein the reconfigurable metasurface unit cells include a set of concentric ring structures and a metal fixed tab formed within the concentric ring structures disposed on a dielectric substrate.

12. The method of claim 9, wherein the plurality of reconfigurable metasurface unit cells each include a set of concentric resonant structures having a subset of phase change material resonant structures of the concentric resonant structures made of a phase change material that, when heated by a refractory heater, switches between conductive material phase to a dielectric material phase to adjust reflection of the reflected radiofrequency signal.

13. The method of claim 9 further comprising:
to pulsing broadband signals to plural access points in the radiofrequency environment from an ultrawide band (UWB) circuit and antenna on the reconfigurable metasurface unit cell array to determine an updated location of the information handling system within the radiofrequency environment; and
executing machine readable program code instructions, via the metasurface hardware controller, of a network access ID management module to adjust the reconfigurable metasurface unit cells to create phase-shifted interference patterns to adjust reflection of incident radiofrequency signals transmitted from the information handling system or received at the information handling system for radiofrequency channels to access an updated set of permitted partitioned wireless connections of the provisioned wireless network at the updated location of the information handling system having new wireless network access permissions based on the wireless network access permission data.

14. An information handling system comprising:
a hardware processor, a memory device, a wireless interface adapter, and a power management unit (PMU) to provide power to the hardware processor, the memory device, and the wireless interface adapter to transceive wireless network data within a radiofrequency (RF) environment;
a reconfigurable metasurface unit cell array operatively coupled to a chassis surface of the information handling system to manipulate electromagnetic (EM) waves of incident radiofrequency signals transmitted or received by plural radiofrequency (RF) antennas on the information handling system, wherein the reconfigurable metasurface unit cell array includes a plurality of reconfigurable metasurface unit cells to adjust reflection of incident radiofrequency signals;
a unique identification (ID) circuit formed on the reconfigurable metasurface unit cell array to receive, from a unique ID circuit writer at an administrator information handling system, wireless network access permission data describing accessibility to partitioned wireless connections in a provisioned wireless network;
an ultrawide band (UWB) circuit and antenna on the reconfigurable metasurface unit cell array to pulse broadband signals to plural access points in the radiofrequency environment to determine a first location of the information handling system within the radiofrequency environment; and
a metasurface hardware controller to execute machine readable program code instructions of a network access ID management module to receive the wireless network access permission data and adjust the reconfigurable metasurface unit cells to create phase-shifted interference patterns to adjust reflection of incident radiofrequency signals transmitted from the information handling system or received at the information handling system to suppress reflection of RF signals for wireless links with restricted partitioned wireless connections of the provisioned wireless network.

15. The information handling system of claim 14 further comprising:
the metasurface hardware controller to execute machine readable program code instructions of the network access ID management module to receive the wireless network access permission data and adjust the reconfigurable metasurface unit cells to create phase-shifted interference patterns to adjust reflection of incident radiofrequency signals transmitted from the information handling system or received at the information handling system to beamform directionality and gain for reflection of RF signals for wireless links with permitted partitioned wireless connections of the provisioned wireless network.

16. The information handling system of claim 14 further comprising:
the reconfigurable metasurface unit cells each including a set of resonant structures to receive and reflect the incident radiofrequency signals and operatively coupled to a tunable phase-shifting circuit to phase-shift reflected RF signals at those reconfigurable metasurface unit cells.

17. The information handling system of claim 14 further comprising:
the reconfigurable metasurface unit cells including a set of concentric resonant structures and a metal fixed tab formed within the concentric resonant structures, where a subset of the concentric resonant structures have reconfigurable conductive and dielectric states to phase-shift reflected RF signals at those reconfigurable metasurface unit cells.

18. The information handling system of claim 17 further comprising:
the metasurface hardware controller to adjust each reconfigurable metasurface unit cell with power supplied to contact pads to operatively couple a refractory heater to a metasurface power source controlled by the metasurface hardware controller to provide power to the first refractory heater to provide a heat pulse to at least one phase change material concentric resonant structure made of phase change material to adjust the reflection phase shift of the reflected RF signal at the reconfigurable metasurface unit cell.

19. The information handling system of claim 14 further comprising:
the UWB circuit to determine a second location of the information handling system within the radiofrequency environment that has changed from the first location; and
the metasurface hardware controller to execute machine readable program code instructions of a network access ID management module to adjust the reconfigurable metasurface unit cells to create phase-shifted interference patterns to adjust reflection of incident radiofrequency signals transmitted from the information handling system or received at the information handling system based on new wireless network access permissions from the wireless network access permission data for the detected second location of the information handling system.

20. The information handling system of claim 14, wherein the network access permission data describing accessibility to wireless connections to a wireless network includes data defining a plurality of different accessibility levels to partitioned wireless connections in a provisioned wireless network for plural physical locations within an RF environment of a physical building.
